(19) United States
(12) Patent Application Publication
(10) Pub. No.: US 2026/0275872 A1
(43) Pub. Date: Sep. 17, 2026

(54) TURBINE BLADE AND GAS TURBINE INCLUDING SAME

(71) Applicant: DOOSAN ENERBILITY CO., LTD., Changwon (KR)

(72) Inventors: Ki Baek Kim, Yongin (KR); Yun Ho An, Sejong (KR); Jeong Ju Kim, Seongnam (KR)

(21) Appl. No.: 19/551,140

(22) Filed: Feb. 26, 2026

(30) Foreign Application Priority Data
Mar. 11, 2025 (KR) 10-2025-0031064

(51) Int. Cl. F01D 5/14; F02C 3/00

(52) U.S. Cl. CPC F01D 5/141; F02C 3/00; F05D 2240/307

(57) ABSTRACT

A turbine blade and a gas turbine including the same are disclosed. The turbine blade includes a blade body and a squealer tip. The blade body includes a leading edge, a trailing edge spaced apart from the leading edge, a suction sidewall having an outwardly convex shape and extending between the leading edge and the trailing edge, a pressure sidewall having an inwardly concave shape and extending between the leading edge and the trailing edge on a side opposite to the suction sidewall, and a tip region on a top surface. The squealer tip extends upward from the tip region of the blade body, and includes a first squealer tip extending upward from the suction sidewall and a second squealer tip extending upward from the pressure sidewall. The first squealer tip and the second squealer tip extend to different heights.

### CROSS REFERENCE TO RELATED APPLICATION

This application claims priority to Korean Patent Application No. 10-2025-0031064, filed on Mar. 11, 2025, the entire contents of which are incorporated herein by reference.

### BACKGROUND

### Technical Field

The disclosure relates to a turbine blade and a gas turbine including the same and, more particularly, to a turbine blade including a squealer tip having a step in a tip region of a blade body, and a gas turbine including the same.

### Description of the Related Art

A turbine is a mechanical device that generates rotational force through impact or reaction of a flow of compressible fluid, such as steam or gas. Examples include steam turbines driven by steam and gas turbines driven by high-temperature combustion gas.

Among these, gas turbines are primarily composed of a compressor, a combustor, and a turbine. The compressor is provided with an air inlet for introducing air, and has a plurality of compressor vanes and a plurality of compressor blades, which are alternately arranged in the compressor casing. Air introduced from an external source is progressively compressed while passing through a plurality of stages of rotating compressor blades, thereby increasing the air pressure to a target level.

The combustor generates high-temperature and high-pressure combustion gas by supplying fuel to the air compressed in the compressor and igniting the fuel using a burner.

The turbine has a plurality of turbine vanes and a plurality of turbine blades alternately arranged in the turbine casing. In addition, a rotor is disposed to extend through the central portion of the compressor, the combustor, the turbine, and the exhaust chamber.

The rotor is rotatably supported at opposite ends by bearings. A plurality of disks are fixed to the rotor to mount the respective blades, and a drive shaft of a generator or the like is connected to one end of the rotor on the exhaust chamber side.

Because these gas turbines lack reciprocating mechanisms such as pistons in four-stroke engines, there are no friction points such as piston-cylinder interfaces. Consequently, there are advantages in that lubricant consumption is extremely low, vibration amplitude characteristic of reciprocating machinery is significantly reduced, and high-speed operation is achievable.

Combustion air compressed by the compressor is mixed with fuel and combusted, thereby producing high-temperature combustion gas. The combustion gas is then ejected toward the turbine. The ejected combustion gas, passing through the turbine vanes and turbine blades, generates rotational force, thereby rotating the rotor.

Factors affecting gas turbine efficiency are highly diverse. In recent gas turbine development, research is being undertaken in various areas, including improving combustion efficiency in the combustor, enhancing thermodynamic efficiency by increasing turbine inlet temperature, improving aerodynamic efficiency in both the compressor and the turbine, and the like.

Here, one of the most critical aspects addressed in improving aerodynamic efficiency in compressors and turbines is gap control at the compressor blades and turbine blade tips. Conventional gas turbine blade tips are designed to have a squealer tip shape. In rotating turbine blades, losses due to tip leakage flow are unavoidable. However, leakage flow may be reduced depending on the turbine blade tip geometry, thereby enhancing the aerodynamic performance of the turbine. Therefore, research on turbine blade tip geometries, which can improve the aerodynamic performance, is currently underway.

### Related Art

United States Patent No. 7,922,451, issued Apr. 12, 2011.

### SUMMARY

Accordingly, the disclosure has been made in view of the above problems in the related art, and is intended to provide a turbine blade and a gas turbine including the same, wherein the turbine blade has an improved squealer tip structure that may reduce tip leakage flow between the blade and a turbine casing, thereby enhancing aerodynamic performance of the turbine while improving cooling efficiency of the turbine.

In order to achieve at least one of the above objectives, according to one aspect of the disclosure, a turbine blade is provided, including: a blade body including a leading edge, a trailing edge spaced apart from the leading edge, a suction sidewall having an outwardly convex shape and extending between the leading edge and the trailing edge, a pressure sidewall having an inwardly concave shape and extending between the leading edge and the trailing edge on a side of the blade body opposite to the suction sidewall, and a tip region on a top surface; and a squealer tip extending upward from the tip region of the blade body, wherein the squealer tip includes a first squealer tip extending upward from the suction sidewall and a second squealer tip extending upward from the pressure sidewall, the first squealer tip and the second squealer tip extending to different heights from the tip region.

In the turbine blade according to the disclosure, the height of the first squealer tip extending from the tip region of the blade body may be greater than the height of the second squealer tip extending from the tip region of the blade body.

The squealer tip may further include a third squealer tip provided between the first squealer tip and the second squealer tip on the tip region of the blade body, the third squealer tip extending upward and inclined toward the second squealer tip. A height of the third squealer tip extending from the tip region of the blade body may be equal to the height of the first squealer tip extending from the tip region of the blade body.

An inclination angle of the third squealer tip inclined toward the second squealer tip from the tip region of the blade body may be between 30° and 90°.

A thickness of each of the first squealer tip, the second squealer tip, and the third squealer tip may be between 1 mm and 3 mm.

A separation width between a lower end portion of the third squealer tip adjacent to the second squealer tip and a surface of the adjacent second squealer tip facing the third squealer tip may be between 1 mm and 5 mm.

A ratio of the height of the second squealer tip extending from the tip region of the blade body relative to a thickness of the tip region of the blade body may be between 0.01 and 0.05.

A ratio of the height of the first squealer tip extending from the tip region of the blade body relative to the thickness of the tip region of the blade body may be between 0.01 and 0.1.

Also provided is a gas turbine including: a compressor configured to compress air introduced from an external source; a combustor configured to generate combustion gas; a plurality of turbine blades configured to be rotated by combustion gas generated by the combustor to generate power, wherein each of the plurality of turbine blades includes: a blade body including a leading edge, a trailing edge spaced apart from the leading edge, a suction sidewall having an outwardly convex shape and extending between the leading edge and the trailing edge, a pressure sidewall having an inwardly concave shape and extending between the leading edge and the trailing edge on a side of the blade body opposite to the suction sidewall, and a tip region on a top surface; and a squealer tip extending upward from the tip region of the blade body, wherein the squealer tip includes a first squealer tip extending upward from the suction sidewall and a second squealer tip extending upward from the pressure sidewall, the first squealer tip and the second squealer tip extending to different heights from the tip region.

In the turbine blade and the gas turbine including the same according to the disclosure, by designing the squealer tip extending upward from the tip region of the blade body to have a stepped and inclined shape, tip leakage flow escaping between the squealer tip and the turbine casing may be reduced, thereby improving the aerodynamics of the turbine.

Furthermore, the stepped and inclined shape of the squealer tip of the turbine blade may reduce mixing with the main flow, thereby improving cooling performance on the pressure sidewall. This enhanced cooling performance may reduce the cooling flow rate.

### BRIEF DESCRIPTION OF THE DRAWINGS

The above and other objectives, features, and other advantages of the disclosure will be more clearly understood from the following detailed description when taken in conjunction with the accompanying drawings, in which:

FIG. 1 is a partially cutaway perspective view illustrating a gas turbine according to embodiments of the disclosure;

FIG. 2 is a cross-sectional view schematically illustrating the structure of the gas turbine shown in FIG. 1;

FIG. 3 is an exploded perspective view illustrating the rotor disk shown in FIG. 2;

FIG. 4 is a schematic view illustrating a turbine blade including a squealer tip according to a first embodiment;

FIG. 5 is an enlarged view illustrating a squealer tip according to a first embodiment, which extends upwardly from a tip region of the turbine blade shown in FIG. 4;

FIG. 6 is a cross-sectional view illustrating the squealer tip shown in FIG. 5;

FIG. 7 is a cross-sectional view illustrating a squealer tip according to a second embodiment, which extends upwardly from a tip region of the turbine blade; and

FIG. 8 is a cross-sectional view illustrating a squealer tip according to a third embodiment, which extends upwardly from a tip region of the turbine blade.

### DETAILED DESCRIPTION

Hereinafter, the disclosure will be described in detail with reference to the accompanying drawings. Unless otherwise defined, terms used in this specification and the claims are to be interpreted according to their ordinary meaning as understood by one of ordinary skill in the art in view of this disclosure.

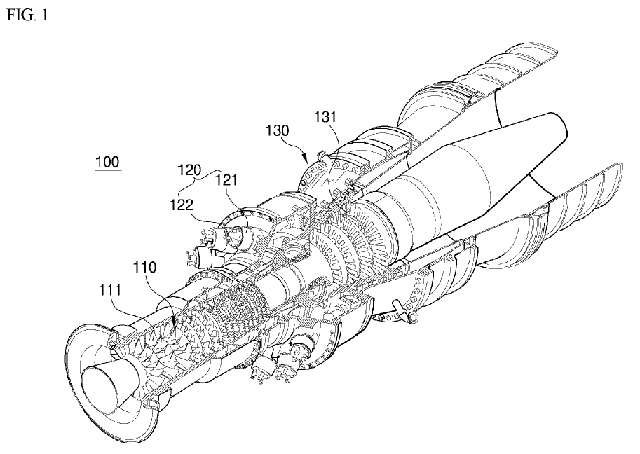

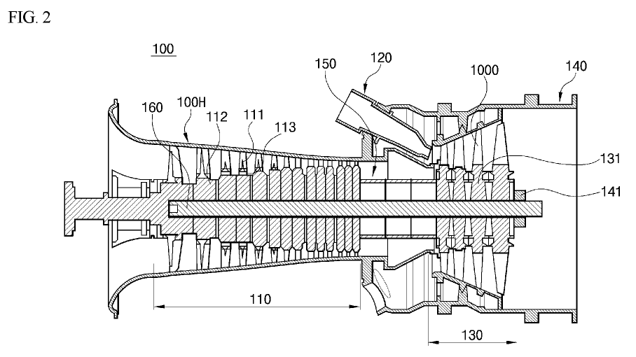

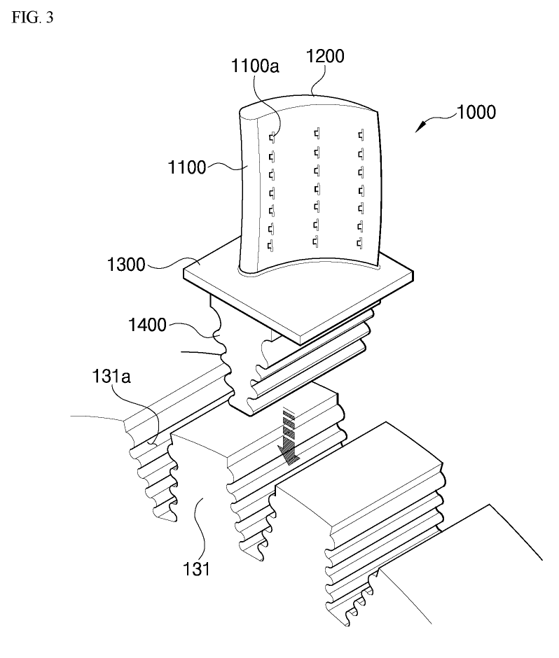

FIG. 1 is a partially cutaway perspective view illustrating a gas turbine according to embodiments of the disclosure, FIG. 2 is a cross-sectional view schematically illustrating the structure of the gas turbine shown in FIG. 1, and FIG. 3 is an exploded perspective view illustrating the rotor disk shown in FIG. 2.

Referring to FIG. 1, a gas turbine 100 according to embodiments of the disclosure includes a compressor 110, a combustor 120, and a turbine 130. The compressor 110 includes a plurality of blades 111 radially arranged therein. The blades 111 are rotated to compress and move air. The size and arrangement angle of the blades 111 may vary depending on the arrangement position. The compressor 110 may be connected directly or indirectly to the turbine 130 to receive a portion of power generated by the turbine 130 for rotating the blades 111.

Air compressed by the compressor 110 moves to the combustor 120. The combustor 120 includes a plurality of combustion chambers 121 arranged in an annular configuration, as well as a fuel nozzle module 122.

Referring to FIGS. 2 and 3, the gas turbine 100 according to an embodiment of the disclosure includes a housing 100H. A diffuser 140 is provided at the rear side of the housing 100H, through which combustion gas which has passed through the turbine 130 is discharged. The combustor 120, which receives and combusts compressed air supplied, is disposed in front of the diffuser 140.

Based on the direction of flow of air, the compressor 110 is positioned upstream of the housing 100H, and the turbine 130 is positioned downstream. In addition, a torque tube unit 150 is disposed between the compressor 110 and the turbine 130. The torque tube unit 150 functions as a torque transmission member to transfer the rotational torque generated in the turbine 130 to the compressor 110.

The compressor 110 is provided with a plurality of (e.g., 14) compressor rotor disks 112, each of which is fastened by a tie rod 160 to prevent axial separation.

Specifically, the respective compressor rotor disks 112 are aligned in the axial direction with the tie rod 160 extending approximately through the centers of the compressor rotor disks 112. Here, the respective compressor rotor disks 112 are arranged such that the opposing surfaces thereof are pressed together by the tie rod 160 to prevent relative rotation.

The plurality of blades 111 are radially coupled to the outer peripheral surfaces of the compressor rotor disks 112. Each of the blades 111 has a dovetail portion 113 by which the blade 111 is fastened to the compressor rotor disk 112.

Vanes (not shown) are provided between the rotor disks 112, and are fixedly disposed in the housing 100H. Unlike the rotor disks, the vanes are fixed so as not to rotate. The vanes serve to align flow of compressed air that has passed through the blades of the compressor rotor disks, thereby guiding the air to the blades of the downstream rotor disks.

The dovetail portion 113 may be fastened to the compressor rotor disk 112 by a tangential type or an axial type. The fastening structure may be selected depending on the required structure of a commercial gas turbine, and may be a conventionally known dovetail or fir tree structure. In some cases, the blades may be fastened to the rotor disks using different fastening devices different from those described above, such as keys or bolts.

The tie rod 160 is disposed to extend through the central portions of the plurality of compressor rotor disks 112 and the turbine rotor disks 131. The tie rod 160 may be implemented as one or a plurality of tie rods. One end of the tie rod 160 is fastened within the uppermost compressor rotor disk, and the other end of the tie rod 160 is fastened by a fixed nut 141.

The configuration of the tie rod 160 may vary depending on the gas turbine design, and is not necessarily limited to the configuration shown in FIG. 2. For example, a single tie rod may extend through the central portions of the rotor disks as shown in the figures, a plurality of tie rods may be arranged circumferentially, or a combination of these configurations may be used.

Although not shown, a vane acting as a guide fin may be disposed at the position next to the diffuser 140 in the compressor of a gas turbine to align the flow angle of fluid entering the combustor inlet with the design flow angle after the fluid pressure is increased. This is referred to as the deswirler.

In the combustor 120, incoming compressed air is mixed with fuel and combusted to produce high-energy, high-temperature, high-pressure combustion gas. In this isothermal combustion process, the temperature of the combustion gas is increased to the maximum heat resistance limit that the combustor and turbine components can withstand.

A plurality of combustors, which constitute the combustion system of the gas turbine, may be arranged in the housing having a cell shape. Each of the combustors includes a burner including a fuel nozzle module 122, a combustor liner forming the combustion chamber, and a transition piece connecting the combustor and the turbine.

Specifically, the liner provides a combustion chamber 121 which serves as a combustion space, in which fuel injected by the fuel nozzle module 122 is mixed with compressed air from the compressor before being combusted. This liner may include a combustion chamber which forms a combustion space in which fuel mixed with air is burned and a flow sleeve which surrounds the combustion chamber and forms an annular space. The fuel nozzle module 122 is coupled to the front end of the liner, and an ignition plug is coupled to the sidewall.

The transition piece is connected to the rear end of the liner to direct combustion gas ignited by the spark plug toward the turbine. The outer wall section of the transition piece is cooled by compressed air which is supplied from the compressor to prevent damage from the high-temperature combustion gas.

In this regard, cooling holes are provided in the transition piece to allow air to be injected internally. The compressed air flows through the cooling holes to cool the main body inside before flowing toward the liner side.

Cooling air flows through the annular space of the liner to cool the transition piece. Compressed air may be supplied from outside the flow sleeve through the cooling holes in the flow sleeve to serve as cooling air and collide with the outer wall of the liner.

The high-temperature and high-pressure combustion gas exiting the combustor is supplied to the turbine 130. The supplied high-temperature and high-pressure combustion gas expands and collides with the rotating blades of the turbine, thereby imparting a reaction force that generates rotational torque. The rotational torque is transmitted to the compressor via the torque tube. Any power exceeding that required to drive the compressor is used to drive the generator or the like.

The structure of the turbine 130 is fundamentally similar to that of the compressor. That is, the turbine 130 also includes a plurality of turbine rotor disks 131 similar to the compressor rotor disks. Therefore, the turbine rotor disks 131 also include a plurality of turbine blades 1000 arranged radially. The turbine blades 1000 may also be coupled to the turbine rotor disks 131 using the dovetail structure or the like. Furthermore, turbine vanes (not shown) are provided between the turbine blades 1000 mounted on adjacent turbine rotor disks 131 and fixed to the housing to guide the flow direction of combustion gas that has passed through the blades.

Referring to FIG. 3, each of the turbine rotor disks 131 has a generally disk-like shape, and a plurality of coupling slots 131a are provided on the outer periphery of the turbine rotor disks. The coupling slots 131a may desirably have a corrugated surface in the shape of a fir tree.

The turbine blades 1000 are fastened in the coupling slots 131a. The turbine blade 1000 has a flat plate-shaped platform portion 1300 approximately on the central portion thereof. The platform portion 1300 has side surfaces in contact with those of the platform portions 1300 of adjacent turbine blades, thereby serving to maintain the gap between the blades.

A root portion 1400 is provided on the bottom surface of the platform portion 1300. The root portion 1400 has an axial-type configuration and is inserted into the corresponding coupling slot 131a of the rotor disk 131 in the axial direction of the rotor disk 131.

The root portion 1400 has a corrugated portion generally in the shape of a fir tree, which conforms to the shape of the corrugated portion of the coupling slot 131a. Here, the coupling structure of the root portion 1400 is not necessarily limited to the fir tree shape and may also have a dovetail structure.

A blade body 1100 is provided on the upper surface of the platform portion 1300. The blade body 1100 is configured to have an airfoil optimized according to the specification of the gas turbine, and includes a leading edge 1110 which is disposed upstream in the flow direction of combustion gas and a trailing edge 1120 which is disposed downstream and spaced apart from the leading edge 1110.

Here, unlike the compressor blades, the turbine blades 1000 come into direct contact with high-temperature and high-pressure combustion gas. Because the temperature of the combustion gas reaches as high as 1700°C, cooling measures are required. In this regard, a cooling flow path is provided that draws in compressed air from specific locations in the compressor and directs the drawn compressed air toward the turbine-side blades.

The cooling flow path may extend from outside the housing (i.e., an external flow path), may extend by passing through the interior of the rotor disk (i.e., an internal flow path), or both external and internal flow paths may be used. In FIG. 3, a plurality of film cooling holes 1100a are provided on the surface of the blade body 1100. The film cooling holes 1100a communicate with cooling channels (not shown) provided inside the blade body 1100 to supply cooling air to the surface of the blade body 1100.

The blade body 1100 of the turbine rotates in the housing by combustion gas. To enable the blade body 1100 to rotate smoothly, a gap is present between the end of the blade body 1100 and the inner surface of the housing. However, because combustion gas may leak through this gap as described above, a sealing means is desired to prevent such leakage.

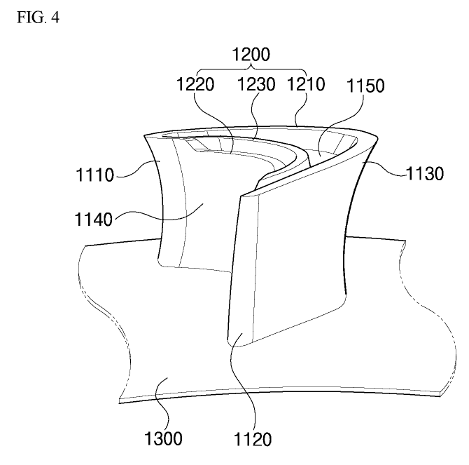

Referring to FIGS. 3 and 4, the blade body 1100 generally includes a leading edge 1110, a trailing edge 1120, a suction sidewall 1130 formed outwardly convex and extending between the leading edge 1110 and the trailing edge 1120, a pressure sidewall 1140 formed inwardly concave and extending between the leading edge 1110 and the trailing edge 1120 on a side of the blade body 1100 opposite to the suction sidewall 1130, and a tip region 1150 on the top surface. The tip region 1150 has a tip gap that allows relative movement with respect to the inner surface of the casing. Due to the pressure difference between an adjacent blade body 1100 and the passage, a strong secondary flow occurs through the tip gap from the pressure sidewall 1140 toward the suction sidewall 1130 of the blade body 1100. This flow is referred to as the tip leakage flow.

The tip leakage flow passes through the tip gap and then moves downstream while spiraling along the suction sidewall. Three-dimensional flow occurring near the tip clearance, such as tip-leakage vortices, significantly increases pressure loss, thereby reducing turbine stage efficiency. The pressure loss caused by this tip leakage flow increases proportionally with the leakage flow rate and is known to account for approximately 30% of the total pressure loss.

To reduce pressure loss caused by tip leakage flow, high-pressure turbine blades currently in use primarily include a squealer tip 1200. The squealer tip 1200 is also referred to as a recessed tip. The squealer tip 1200 extends upward from the tip region 1150, and has a fence-like protrusion on the tip edge as well as a recessed cavity. The turbine blade 1000 having the squealer tip 1200 reduces tip leakage flow compared to a turbine blade having a flat tip.

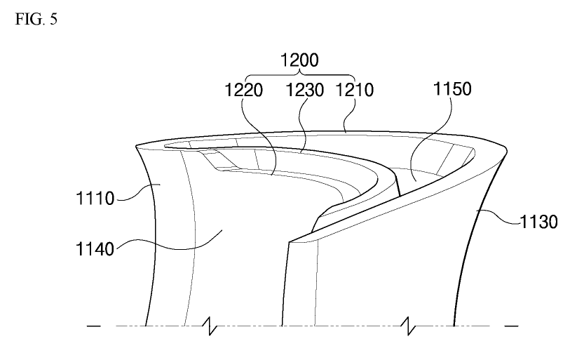

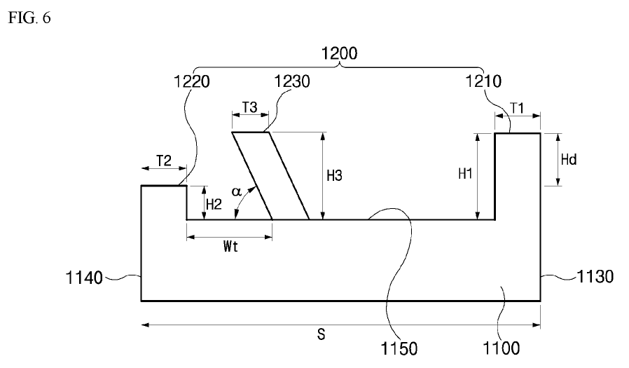

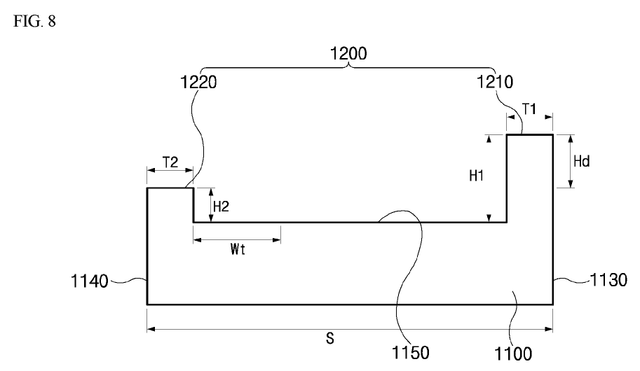

Referring to FIGS. 5 to 8, the squealer tip 1200 may include a first squealer tip 1210 and a second squealer tip 1220. The first squealer tip 1210 extends upward from the suction sidewall 1130, and the second squealer tip 1220 extends upward from the pressure sidewall 1140.

The first squealer tip 1210 and the second squealer tip 1220, which extend upward from the tip region 1150, extend to different heights. It is desirable that the height H1 to which the first squealer tip 1210 extends is greater than the height H2 to which the second squealer tip 1220 extends.

Referring to FIGS. 5 to 7, the squealer tip 1200 may further include a third squealer tip 1230, which is provided between the first squealer tip 1210 and the second squealer tip 1220. The third squealer tip 1230 extends upward from the tip region 1150 and is inclined toward the second squealer tip 1220. It is desirable that the height H3 of the third squealer tip 1230 is the same as the height H1 of the first squealer tip 1210.

A stepped configuration of the first squealer tip 1210, the third squealer tip 1230, and the second squealer tip 1220, and an inclined configuration of the third squealer tip 1230 may reduce mixing with the main flow, thereby improving cooling performance on the pressure sidewall 1140.

The third squealer tip 1230 is inclined toward the second squealer tip 1220 from the tip region 1150 of the blade body 1100. The inclination angle α is desirably 30° ≤ α ≤ 90°.

In a case where the inclination angle α of the third squealer tip 1230 toward the second squealer tip 1220 is less than 30°, the angle is sharper, thereby resulting in reduced manufacturability. In a case where the inclination angle α of the third squealer tip 1230 is greater than 90°, the effect of reducing tip leakage flow is lost.

The thicknesses T1, T2, and T3 of the first squealer tip 1210, the second squealer tip 1220, and the third squealer tip 1230, which extend upward from the tip region 1150, are desirably between 1 mm and 3 mm.

In a case where the thicknesses T1, T2, and T3 of the first squealer tip 1210, the second squealer tip 1220, and the third squealer tip 1230 are less than 1 mm, casting properties may be poor, thereby causing quality issues during production. In a case where the thicknesses T1, T2, and T3 are greater than 3 mm, the area to be cooled may increase, and the effect of reducing tip leakage flow may be lost.

It is desirable that a lower end portion of the third squealer tip 1230 adjacent to the second squealer tip 1220 be spaced apart from a surface of the adjacent second squealer tip 1220 facing the third squealer tip 1230 by a separation width Wt between 1 mm and 5 mm.

In a case where the separation width Wt between the lower end portion of the third squealer tip 1230 and the surface of the second squealer tip 1220 facing the third squealer tip 1230 is less than 1 mm, the casting quality may deteriorate, thereby leading to manufacturing quality issues. In a case where the separation width Wt is greater than 5 mm, problems arise with the shape of the blade tip, thereby preventing the third squealer tip 1230 from performing the intended function.

It is desirable that the ratio of the height H2 to which the second squealer tip 1220 extends from the tip region 1150 of the blade body 1100 relative to the thickness S of the tip region 1150 of the blade body 1100 is 0.01 ≤ H2/S ≤ 0.05. In a case where the ratio of the height H2 by which the second squealer tip 1220 extends from the tip region 1150 of the blade body 1100 relative to the thickness S of the tip region 1150 of the blade body 1100 is less than 0.01, manufacturability may be reduced. In a case where the ratio H2/S is greater than 0.05, the stepped configuration effect may be lost.

Furthermore, it is desirable that the ratio of the height H1 of the first squealer tip extending from the tip region of the blade body relative to the thickness S of the tip region of the blade body is between 0.01 and 0.1.

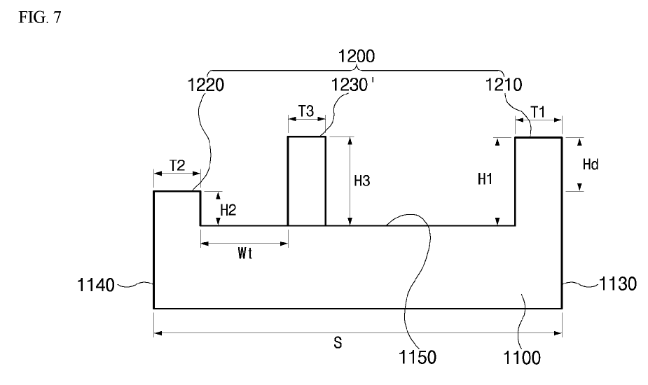

Referring to FIG. 7, the third squealer tip 1230’ may, in some implementations, extend vertically from the tip region 1150 of the blade body 1100 without being inclined toward the second squealer tip 1220. It is desirable that the height H3 and the thickness T3 of the third squealer tip 1230’ be the same as the height H1 and the thickness T1 of the first squealer tip 1210.

Therefore, by designing the squealer tip 1200 extending upward from the tip region 1150 of the blade body 1100 to have a stepped and inclined shape, the tip leakage flow escaping between the squealer tip and the turbine casing may be reduced, thereby improving the aerodynamics of the turbine.

Furthermore, the stepped and inclined shape of the squealer tip 1200 of the turbine blade 1000 may reduce mixing with the main flow, thereby improving cooling performance on the pressure sidewall 1140. This enhanced cooling performance may reduce the cooling flow rate.

The disclosure has been described with reference to the embodiments illustrated in the drawings, but these are merely illustrative, and a person having ordinary skill in the art will understand that various modifications and equivalent embodiments are possible based thereon. Therefore, the full scope of the technical protection of the disclosure should be determined by the technical concepts set forth in the appended claims.

What is claimed is:

1. A turbine blade comprising:
a blade body comprising a leading edge, a trailing edge spaced apart from the leading edge, a suction sidewall having an outwardly convex shape and extending between the leading edge and the trailing edge, a pressure sidewall having an inwardly concave shape and extending between the leading edge and the trailing edge on a side of the blade body opposite to the suction sidewall, and a tip region on a top surface; and
a squealer tip extending upward from the tip region of the blade body,
wherein the squealer tip comprises a first squealer tip extending upward from the suction sidewall and a second squealer tip extending upward from the pressure sidewall, the first squealer tip and the second squealer tip extending to different heights from the tip region.

2. The turbine blade of claim 1, wherein the height of the first squealer tip extending from the tip region of the blade body is greater than the height of the second squealer tip extending from the tip region of the blade body.

3. The turbine blade of claim 2, wherein the squealer tip further comprises a third squealer tip provided between the first squealer tip and the second squealer tip on the tip region of the blade body, the third squealer tip extending upward and inclined toward the second squealer tip,
wherein a height of the third squealer tip extending from the tip region of the blade body is equal to the height of the first squealer tip extending from the tip region of the blade body.

4. The turbine blade of claim 3, wherein an inclination angle of the third squealer tip inclined toward the second squealer tip from the tip region of the blade body is between 30° and 90°.

5. The turbine blade of claim 3, wherein a thickness of each of the first squealer tip, the second squealer tip, and the third squealer tip is between 1 mm and 3 mm.

6. The turbine blade of claim 3, wherein a separation width between a lower end portion of the third squealer tip adjacent to the second squealer tip and a surface of the adjacent second squealer tip facing the third squealer tip is between 1 mm and 5 mm.

7. The turbine blade of claim 3, wherein a ratio of the height of the second squealer tip extending from the tip region of the blade body relative to a thickness of the tip region of the blade body is between 0.01 and 0.05.

8. The turbine blade of claim 7, wherein a ratio of the height of the first squealer tip extending from the tip region of the blade body relative to the thickness of the tip region of the blade body is between 0.01 and 0.1.

9. A gas turbine comprising:
a compressor configured to compress air introduced from an external source;
a combustor configured to generate combustion gas;
a plurality of turbine blades configured to be rotated by combustion gas generated by the combustor to generate power,
wherein each of the plurality of turbine blades comprises:
a blade body comprising a leading edge, a trailing edge spaced apart from the leading edge, a suction sidewall having an outwardly convex shape and extending between the leading edge and the trailing edge, a pressure sidewall having an inwardly concave shape and extending between the leading edge and the trailing edge on a side of the blade body opposite to the suction sidewall, and a tip region on a top surface; and
a squealer tip extending upward from the tip region of the blade body,
wherein the squealer tip comprises a first squealer tip extending upward from the suction sidewall and a second squealer tip extending upward from the pressure sidewall, the first squealer tip and the second squealer tip extending to different heights from the tip region.

10. The gas turbine of claim 9, wherein the height of the first squealer tip extending from the tip region of the blade body is greater than the height of the second squealer tip extending from the tip region of the blade body.

11. The gas turbine of claim 10, wherein the squealer tip further comprises a third squealer tip provided between the first squealer tip and the second squealer tip on the tip region of the blade body, the third squealer tip extending upward and inclined toward the second squealer tip,
wherein a height of the third squealer tip extending from the tip region of the blade body is equal to the height of the first squealer tip extending from the tip region of the blade body.

12. The gas turbine of claim 11, wherein an inclination angle of the third squealer tip inclined toward the second squealer tip from the tip region of the blade body is between 30° and 90°.

13. The gas turbine of claim 11, wherein a thickness of each of the first squealer tip, the second squealer tip, and the third squealer tip is between 1 mm and 3 mm.

14. The gas turbine of claim 11, wherein a separation width between a lower end portion of the third squealer tip adjacent to the second squealer tip and a surface of the adjacent second squealer tip facing the third squealer tip is between 1 mm and 5 mm.

15. The gas turbine of claim 11, wherein a ratio of the height of the second squealer tip extending from the tip region of the blade body relative to a thickness of the tip region of the blade body is between 0.01 and 0.05, and
a ratio of the height of the first squealer tip extending from the tip region of the blade body relative to the thickness of the tip region of the blade body is between 0.01 and 0.1.
